(19) United States
(12) Patent Application Publication
(10) Pub. No.: US 2021/0303793 A1
(43) Pub. Date: Sep. 30, 2021

(54) ROOT CAUSE CLASSIFICATION

(71) Applicant: AT&T Intellectual Property I, L.P., Atlanta, GA (US)

(72) Inventors: Yunmiao Wang, Garland, TX (US); Prateek Baranwal, Dallas, TX (US); Martin Patrick McEnroe, Plano, TX (US); Ni An, Plano, TX (US)

(21) Appl. No.: 16/829,892

(22) Filed: Mar. 25, 2020

(51) Int. Cl. G06F 40/30; G06N 3/08; G06N 3/04; G06Q 30/00; G06F 40/232; G06F 40/166; G06F 40/284

(52) U.S. Cl. CPC G06F 40/30; G06N 3/08; G06N 3/0445; G06F 40/284; G06Q 30/016; G06F 40/232; G06F 40/166; G06N 3/0454

(57) ABSTRACT

An example method performed by a processing system includes acquiring a set of troubleshooting notes. The set of troubleshooting notes is generated by a human customer support representative in response to a condition that is reported by a customer. The troubleshooting notes are written in natural language. A plurality of predictions for the set of troubleshooting notes is generated. Each prediction of the plurality of predictions indicates a likelihood that a root cause of the condition is a different one of a plurality of predefined root causes, and each prediction of the plurality of predictions is generated using a different binary classifier of a plurality of binary classifiers. At least two of the plurality of predictions are encoded into a single vector which concatenates a plurality of bits, wherein each bit of the plurality of bits represents one prediction of the at least two of the plurality of predictions.

The present disclosure relates generally to troubleshooting and relates more particularly to methods, apparatuses, and non-transitory computer-readable media for natural language processing-based root cause analysis.

### BACKGROUND

Customer support encompasses a wide range of customer services designed to assist customers in the use of products and services. One specific aspect of customer support, namely, technical support, is designed to assist in the use of technology products and services, such as mobile phones, software products, Internet and mobility services, and the like. For instance, the customer support department of a network service provider may receive customer calls related to various troubles that customers may experience with any number of services that are provided by the network service provider (e.g., a data service, a voice service, a video streaming service, etc.).

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates a flowchart of an example method for training a classifier to perform root cause analysis, in accordance with the present disclosure;

FIG. 3 illustrates an example set of consolidated root cause labels for an example telecommunications service provider;

FIG. 4 illustrates a flowchart of an example method for classifying the root cause of a reported condition, in accordance with the present disclosure;

FIG. 5 illustrates an example report that may be generated from a plurality of vectors that are generated in accordance with steps of the method of FIG. 4; and

FIG. 6 depicts a high-level block diagram of a computer suitable for use in performing the functions described herein.

To facilitate understanding, identical reference numerals have been used, where possible, to designate identical elements that are common to the figures.

### DETAILED DESCRIPTION

The present disclosure relates to a method and apparatus for predicting of classifying root causes of conditions reported by customers of a technical product or service provider. In one example, a method performed by a processing system of a customer support system includes acquiring a set of troubleshooting notes, wherein the set of troubleshooting notes is generated by a human customer support representative in response to a condition that is reported by a customer, and wherein the troubleshooting notes are written in natural language, generating a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers, and encoding at least two of the plurality of predictions into a single vector which concatenates a plurality of bits, wherein each bit of the plurality of bits represents one prediction of the at least two of the plurality of predictions

In another example, a non-transitory computer-readable storage device stores a plurality of instructions which, when executed by a processing system of a customer support system, cause the processing system to perform operations. The operations include acquiring a set of troubleshooting notes, wherein the set of troubleshooting notes is generated by a human customer support representative in response to a condition that is reported by a customer, and wherein the troubleshooting notes are written in natural language, generating a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers, and encoding at least two of the plurality of predictions into a single vector which concatenates a plurality of bits, wherein each bit of the plurality of bits represents one prediction of the at least two of the plurality of predictions.

In another example, an apparatus includes a processing system of a customer support system and a non-transitory computer-readable storage device storing a plurality of instructions which, when executed by the processing system, cause the processing system to perform operations. The operations include acquiring a set of troubleshooting notes, wherein the set of troubleshooting notes is generated by a human customer support representative in response to a condition that is reported by a customer, and wherein the troubleshooting notes are written in natural language, generating a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers, and encoding at least two of the plurality of predictions into a single vector which concatenates a plurality of bits, wherein each bit of the plurality of bits represents one prediction of the at least two of the plurality of predictions.

As described above, technical support is an area of customer support that is designed to assist in the use of technology products and services, such as mobile phones, software products, Internet and mobility services, and the like. For example, a customer who experiences a problem while trying to use a technology product or service may contact a technical support representative, who may ask for information about the customer's experience with the technology product or service in order to try to identify a root cause of the problem. Once the root cause has been identified, the technical support representative may be able to take or recommend measures that may resolve the problem.

An initial step of root cause analysis is to define and describe the problem space. Within the context of the present disclosure, a “problem space” is understood to refer to all of the various potential errors that could lead to the same type of failure or event. For instance, if the display of a customer's laptop computer is blank, the problem space may include the possibilities that the laptop computer's battery is dead, that the random access memory (RAM) of the laptop computer is faulty, that a component of the display (e.g., a light emitting diode (LED)) is broken, and/or other errors. Similarly, self-installation of hardware by a customer may fail due to a customer registration error, due to shipment of the wrong toolkit to the customer, and/or due to other errors.

Thus, the success rate for a particular event (i.e., attempt to use a technology product or service) can be improved by identifying all of the specific errors that may cause the event to fail, prioritizing these errors based on the frequency with which the errors lead to failure of the event, and focusing efforts on eliminating the errors for which the frequency is highest. In addition, it may be worthwhile from a technical support perspective to monitor the volume change of failure modes for at least two reasons: (1) monitoring may help to confirm whether a measure that was taken to resolve a problem was effective; and (2) if performed continuously, monitoring may help to identify newly emerging problems before the newly emerging problems become more widespread.

Conventionally, root cause analysis is conducted by human subject matter experts who may manually review the logs (e.g., troubleshooting notes) of technical support representatives. The logs may describe the specific problems that were referred to the technical support representatives as well as the actions that were taken to resolve the problems. Although this approach may successfully identify the root causes of at least some of the problems, it is inefficient from both a time and cost perspective since it relies on the efforts of a small number of qualified individuals reviewing a large amount of data. Moreover, this approach is subject to human error, since even subject matter experts may be prone to reading biases and disagreements.

Additionally, conventional root cause analysis tends to identify a single root cause as the source of a problem, when, in reality, multiple root causes may contribute to a problem. For instance, a blank laptop computer display could be caused by both a dead battery and a broken LED. If efforts to resolve the problem focus on only one of these causes (e.g. on only charging the battery or only replacing the broken LED), the problem may persist.

Examples of the present disclosure perform root cause analysis and trend monitoring using automatic, natural language processing techniques that are faster and less prone to reading biases than human subject matter experts. In some examples, natural language processing techniques may be used to generate labels for a plurality of sets of troubleshooting notes that are used as training data. For instance, the plurality of sets of troubleshooting notes may be pre-processed and clustered into a plurality of clusters based on similarities in word representation (e.g., frequencies of specific words, word counts, etc.). Topic modeling may then be used to assign labels to the clusters, where the label for a given cluster identifies the probable root cause of the problems associated with the sets of troubleshooting notes that are included in the cluster. The labeled troubleshooting notes may then be used to train a supervised machine learning model to identify the root causes associated with unlabeled sets of troubleshooting notes.

In some examples, the machine learning model may identify at least two root causes that are associated with an unlabeled set of troubleshooting notes. For instance, the machine learning model may include a plurality of binary classifiers, where each binary classifier is trained, based on the labeling process described above, to identify a respective root cause of a plurality of predefined root causes. When an unlabeled set of troubleshooting notes is input to the machine learning model, each binary classifier may output a likelihood that the binary classifier's respective root cause is the cause of a condition associated with the unlabeled set of troubleshooting notes. More than one of the binary classifiers may output a positive indicator (i.e., an indicator that the respective root cause is a cause of the condition). The machine learning model may encode the outputs of all of the binary classifiers into a single vector, such that the single vector indicates, for each root cause of the plurality of root causes, the likelihood that the root cause contributed to the condition.

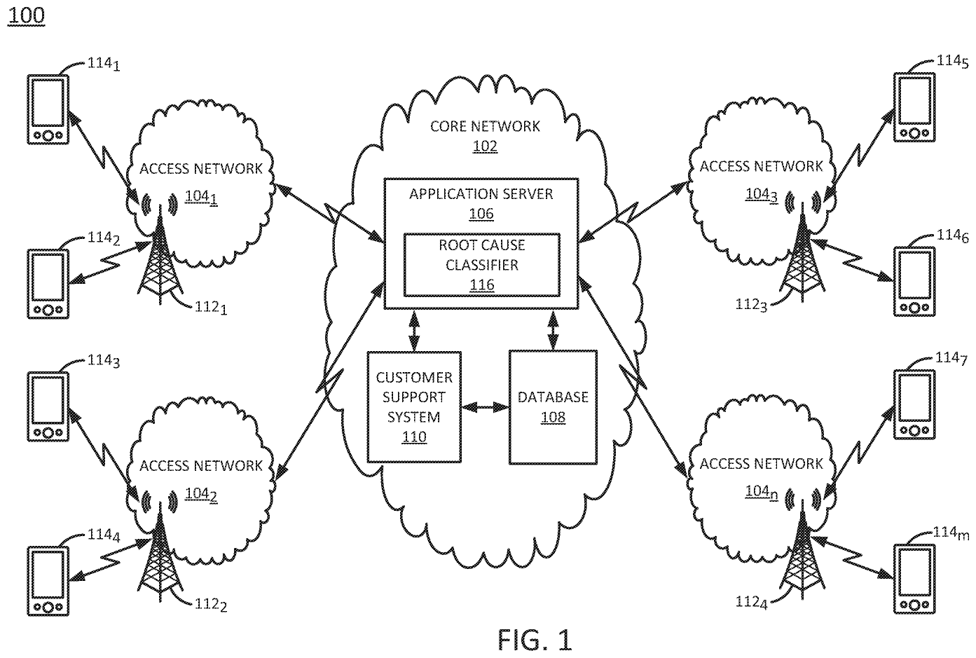

FIG. 1 illustrates an example network 100 related to the present disclosure. In one example, the network 100 may comprise a core network 102 that is communicatively coupled to one or more access networks 104₁-104ₙ (hereinafter individually referred to as an “access network 104” or collectively referred to as “access networks 104”).

In one example, the core network 102 may combine core network components of a wired or cellular network with components of a triple play service network, where triple-play services include telephone services (e.g., wireless and/or fixed-line telephone services), Internet services, and television services to subscribers. For example, the core network 102 may functionally comprise a fixed mobile convergence (FMC) network, e.g., an Internet Protocol (IP) Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. The core network 102 may further comprise a broadcast television network, e.g., a traditional cable provider network or an Internet Protocol Television (IPTV) network, as well as an Internet Service Provider (ISP) network. In one example, the core network 102 may include a plurality of television (TV) servers (e.g., a broadcast server, a cable head-end), a plurality of content servers, an advertising server (AS), an interactive TV/video on demand (VoD) server, and so forth (not shown). For ease of illustration, various additional elements of network 102 are omitted from FIG. 1.

In one example, the access networks 104 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and/or the like. For example, the operator of the core network 102 may provide a cable television service, an IPTV service, or any other types of telecommunication services to subscribers via access networks 104. In one example, the access networks 104 may comprise different types of access networks, may comprise the same type of access network, or some access networks may be the same type of access network and other may be different types of access networks. In one example, the core network 102 may be operated by a telecommunication network service provider. The core network 102 and the access networks 104 may be operated by different service providers, the same service provider, or a combination thereof, or the access networks 104 may be operated by entities having core businesses that are not related to telecommunications services, e.g., corporate, governmental, or educational institution local area networks (LANs), and the like.

In one example, each access network 104 includes at least one network element 112₁-112ₙ (hereinafter individually referred to as a “network element 112” or collectively referred to as “network elements 112”). The network elements 112 may comprise network elements of a cellular network (e.g., base stations, eNodeBs and the like), routers, gateway servers, and the like.

In one example, each of the access networks 104 may be in communication with one or more user endpoint devices 114₁-114ₘ (hereinafter individually referred to as a “user endpoint device 114” of collectively referred to as “user endpoint devices 114”). The access networks 104 may transmit and receive communications between the user endpoint devices 114, between the user endpoint devices 114 and other components of the core network 102, and so forth. In one example, each of user endpoint devices 114 may comprise any single device or combination of devices that may comprise a user endpoint device. For example, each user endpoint device 114 may comprise a mobile device, a cellular smart phone, a gaming console, a set top box, a laptop computer, a tablet computer, a desktop computer, an application server, a bank or cluster of such devices, and the like. In one example, any of the user endpoint devices 114 may comprise a sensor device with wireless networking hardware, e.g., an Internet of Things (IoT) device, for gathering measurements of an environment, uploading the measurements to one or more servers or other devices, and so forth.

In one example, the core network 102 may include an application server 106, a database or database server 108, and a customer support system 110. The application server 106 may be communicatively coupled to the database 108 and to the customer support system 110. The database 108 may also be communicatively coupled to the customer support system 110.

In one example, the customer support system 110 may comprise one or more devices (e.g., computing devices, servers, databases, etc.) that may be operable by a team of human technical support representatives of a specific technology product or service provider (e.g., an operator of the core network 102, an operator of one or more of the access networks 104, a manufacturer of one or more of the user endpoint devices 114, and/or other providers of goods and services that are provided via or provided with access to the network 100). The customer support system 110 may receive reports from customers of the technology product or service provider (e.g., users of the endpoint devices 114), where the reports may report the occurrences of conditions (e.g., technical problems) affecting use by the customers of the technology product or service provider's products or services. For instance, where the technology product or service provider is a telecommunications network service provider, the reports may include reports of problems customers have experienced (e.g., dropped voice calls, poor service coverage, etc.). The customer support system 110 may generate tickets or other forms of records for the reported conditions, where the tickets may uniquely identify each reported condition.

Each ticketed condition may be assigned to one or more of the human technical support representatives for resolution. The human technical support representative(s) may communicate with the customer to attempt to diagnose the root cause of the condition and may further recommend or take measures to resolve the condition. For instance, the human technical support representative(s) may recommend that the customer install a software update on the hardware that is used to access the telecommunications network service (e.g., the customer's smart phone). Alternatively, the telecommunications network service may notify appropriate personnel within the telecommunications network service provider that there is a problem with the telecommunications network service provider's equipment (e.g., a malfunctioning base station).

In one example, the database 108 may store information about the conditions reported to the customer support system 110. For instance, the database 108 may store an index of the tickets that are assigned to the conditions. The database 108 may also store logs or transcripts of customer calls related to the conditions (e.g., conversations between the customers and technical support representatives). The logs or transcripts may include troubleshooting notes that were made by the technical support representatives in the process of fielding the calls (e.g., where the notes may include information that was not verbalized during the calls).

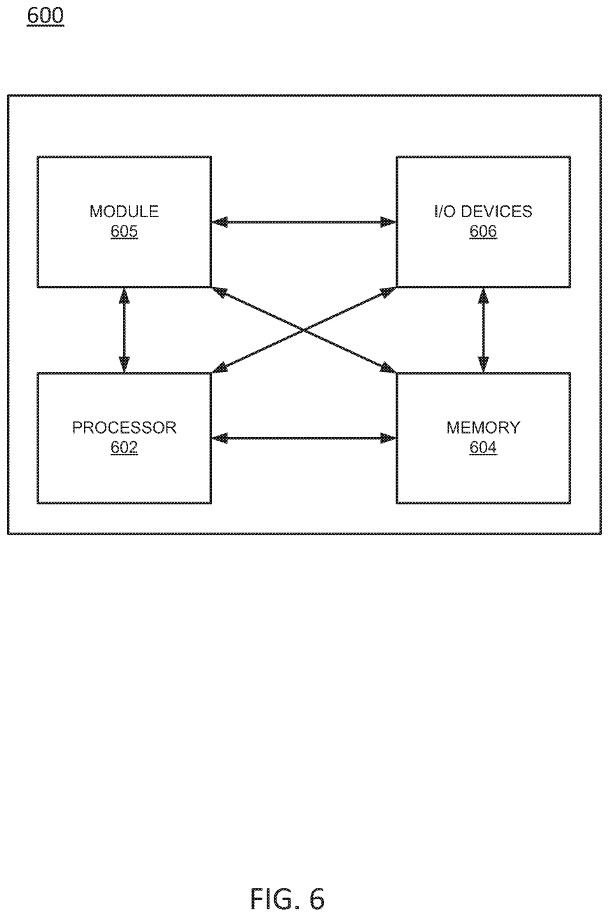

In one example, the application server 106 is a dedicated network hardware element configured to perform the methods and functions described herein (e.g., the methods 200 and 400 discussed below). For example, the application server 106 may be deployed as a hardware device embodied as a dedicated server (e.g., the dedicated computer 600 as illustrated in FIG. 6). In other words, the application server 106 is for performing root cause analysis in accordance with the teachings of the present disclosure.

In one example, the application server 106 may include a root cause classifier 116 that is used for performing root cause analysis. The root cause classifier may include a plurality of binary classifiers (not shown), where each binary classifier has been trained (e.g., using labeled training data) to predict a likelihood of a respective root cause contributing to a condition associated with a set of troubleshooting notes (where the set of troubleshooting notes may be unlabeled) Each binary classifier of the plurality of binary classifiers may comprise the same type of classifier. Alternatively the plurality of binary classifiers may comprise a plurality of different types of classifiers (e.g., at least two classifiers of the plurality of binary classifiers are different types of classifiers). In one example, the plurality of binary classifiers may include at least one of: a naïve Bayesian classifier and a logistic regression classifier.

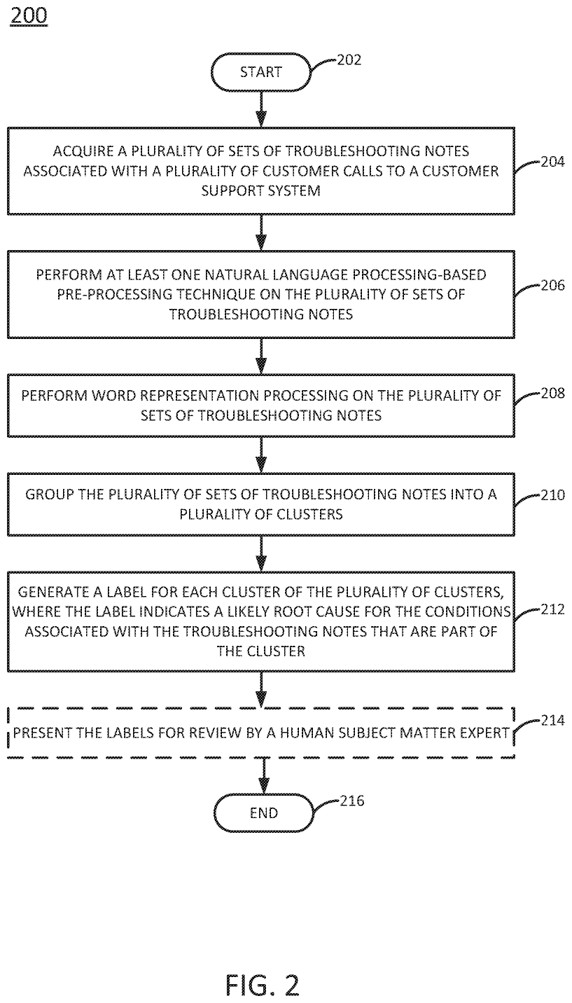

In one example, the labeled training data may include sets of troubleshooting notes associated with customer calls, where the sets of troubleshooting notes may be stored in the database 108. Each set of troubleshooting notes may be labeled with the likely root cause of the condition associated with the set of troubleshooting notes. One example of a method for labeling training data for use in training the binary classifiers is discussed in greater detail in connection with FIG. 2.

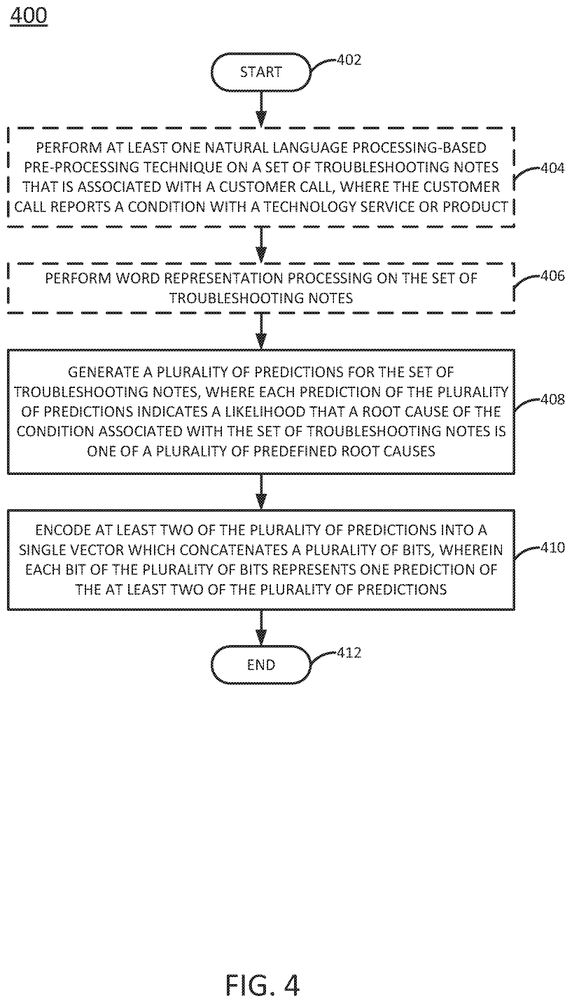

Each binary classifier may output a separate prediction (e.g., likely or not likely), and the separate predictions may be encoded into a single vector by the application server 106. The single vector may identify at least one (and, in one specific example, may identify at least two) likely root causes of a condition associated with the set of troubleshooting notes. One example of a method for generating the single vector is described in greater detail in connection with FIG. 4.

The predictions that are output by the root cause classifier 116 (e.g., root causes that are assigned to reported conditions) may be stored in the database 108. The information about the assigned root causes may be used to detect and monitor trends in customer-reported conditions, as discussed in greater detail below. The application server 106 may access the data stored in the database 108 when performing an analysis to identify the root cause of a reported condition and when performing an analysis to discover and/or monitor trends.

Although a single application server 106 and a single database or database server 108 is shown in core network 102 of FIG. 1, various types of data may be stored in any number of databases or database servers. For instance, various databases, e.g., databases for user endpoint devices, for submarkets, for operating system versions of user endpoint devices, for abnormal cause codes of user groups, for notices to be sent to a customer support system, for tickets that are generated, etc., may be deployed. In addition, various types of data may also be stored in a cloud storage. In other words, the network service provider may implement the service for performing root cause analysis of the present disclosure by storing data in a cloud storage and/or a centralized server.

It should be noted that the network 100 has been simplified. That is, the network 100 may include additional networks and/or network elements that are not illustrated in FIG. 1. For example, the access networks 104 and the core network 102 of FIG. 1 may include additional network elements such as base stations, border elements, gateways (e.g., serving gateways, packet data network gateways, etc.), firewalls, routers, switches, call control elements, mobility management entities, various application servers (e.g., home subscriber servers, feature servers, etc.), and the like.

FIG. 2 illustrates a flowchart of an example method 200 for training a classifier to perform root cause analysis, in accordance with the present disclosure. In particular, the method 200 may automatically generate root cause labels for a plurality of conditions based on a plurality of sets of troubleshooting notes associated with the conditions, where the root cause labels and the sets of troubleshooting notes may serve as training data for training a supervised machine learning model to classify the root causes of conditions associated with unlabeled sets of troubleshooting notes. In other examples, however, the root cause labels may be generated manually by a human subject matter expert. For instance, the human subject matter expert may review each set troubleshooting notes and, based on the review, may assign root cause labels that are believed to best identify the root causes of the conditions associated with each set of troubleshooting notes.

In one example, steps, functions and/or operations of the method 200 may be performed by a device as illustrated in FIG. 1, e.g., the application server 106 or any one or more components thereof (e.g., the root cause classifier 116). In one example, the steps, functions, or operations of method 200 may be performed by a computing device or system 600, and/or a processing system 602 as described in connection with FIG. 6 below. For instance, the computing device 600 may represent at least a portion of the application server 106 in accordance with the present disclosure. For illustrative purposes, the method 200 is described in greater detail below in connection with an example performed by a processing system, such as processing system 602.

The method 200 may begin in step 202. In step 204, the processing system may acquire a plurality of sets of troubleshooting notes associated with a plurality of customer calls to a customer support system. The customer calls may comprise voice calls, text messaging exchanges, Web chat interactions, or any other forms of interaction in which a customer may communicate with a technical support representative in order to report and attempt to resolve a condition with a technology service or product.

Each customer call of the plurality of customer calls may be associated with a respective identifier (e.g., a ticket number, a reference number, or another identifier), respective transcript or recording of the interaction, and respective set of troubleshooting notes. In addition, each customer call may be further associated with respective metadata which may indicate when the customer call took place (e.g., date and/or time), a location from which the customer call originated (e.g., from where the customer was calling), the product or service that was the subject of the customer call, whether the reported condition was successfully resolved, and/or other information.

The set of troubleshooting notes associated with a customer call may include information noted by the technical support representative as the technical support representative attempted to resolve the reported condition, as opposed to any statements that may have been verbalized during the interaction with the customer. For instance, the troubleshooting notes may be meant to help other technical support representatives who may attempt to resolve similar conditions in the future. The troubleshooting notes might include, for example, actions that were taken in an attempt to resolve the condition that failed, actions that were taken in an attempt to resolve the condition that succeeded or partially succeeded, identities of other individuals or experts who may have been consulted by the technical support representative, observed symptoms of the condition (including symptoms that are most strongly associated with the condition), and/or other information. In one example, each set of troubleshooting notes is associated with one customer call.

In step 206, the processing system may perform at least one natural language processing-based pre-processing technique on the plurality of sets of troubleshooting notes. The pre-processing may help to convert the sets of troubleshooting notes into simpler, more uniform forms that are easier to compare to each other (which may aid in a later clustering process, described in further detail below). In one example, the at least one natural language processing-based pre-processing technique may be at least one of the following: misspelling correction (e.g., correcting the spelling of misspelled words in a set of troubleshooting notes), stop word removal (e.g., removing stop words—such as “a,” “an,” “the,” “and,” and the like—from a set of troubleshooting notes), identification of domain- or service provider-specific terminology (e.g., the abbreviation “RG” in a set of troubleshooting notes may be short for “residential gateway” if the set of troubleshooting notes comes from a telecommunications service provider), normalization of numbers and combinations of letters and numbers (e.g., spelling out numbers that have been indicated in numeric form), and lemmatization of inflected forms of words (e.g., converting the modified form of a word—which may be used to express a particular tense, case, voice, number, or the like—into the word's base form).

In step 208, the processing system may perform word representation processing on the plurality of sets of troubleshooting notes. The word representation processing may further simplify the sets of troubleshooting notes for comparison and clustering. In one example, a bag of words model may be used to simplify the sets of troubleshooting notes by representing the text of each set of troubleshooting notes as a multiset of words (disregarding grammar and word order). For instance, the bag of words model may indicate how many times each word of a plurality of words appears in a set of troubleshooting notes. In further examples, the bag of words model may indicate a term frequency-inverse document frequency (TF-IDF) statistic for a set of troubleshooting notes. The TF-IDF may reflect, for instance, how important particular words are to the set of troubleshooting notes. As an example, the TF-IDF for a given set of troubleshooting notes may comprise a value that increases with the frequency of a word in the given set of troubleshooting notes, offset by the number of troubleshooting notes in the plurality of troubleshooting notes that contain the word.

In another example, a word embedding model may be used to simplify the sets of troubleshooting notes by mapping words or phrases appearing in the sets of troubleshooting notes to vectors of real numbers. The word embedding model may quantify and categorize semantic similarities between words or phrases appearing in the plurality of sets of troubleshooting notes, based on the distributions of the words or phrases in the plurality of sets of troubleshooting notes. In one example, the word embedding model may comprise a word2vec model, a fastText model, a GloVe model, or a bidirectional encoder representations from transformers (BERT) model.

In step 210, the processing system may group the plurality of sets of troubleshooting notes (which have been pre-processed and simplified according to steps 206 and 208) into a plurality of clusters. One aim of the clustering process is to consolidate the sets of troubleshooting notes into groups that are related to the same or similar conditions. In one example, the clustering process may be guided by natural language processing techniques in order to identify similarities among the plurality of sets of processing notes. In one example, any one or more of a number of clustering techniques may be used to group the plurality of sets of troubleshooting notes into the plurality of clusters, including k-means clustering and hierarchical clustering.

In step 212, the processing system may generate a label for each cluster of the plurality of clusters, where the label may indicate a root cause for the conditions associated with the sets of troubleshooting notes that are part of the cluster. In one example, a topic modeling technique may be used to uncover a hidden structure in the collection of text strings (e.g., sets troubleshooting notes) within each cluster. In one example, any one or more of a number of topic modeling techniques may be employed to generate the root cause labels. For instance, the topic modeling techniques that may be used to generate the root cause labels may include latent Dirichlet allocation (LDA), latent semantic analysis (LSA), non-negative matrix factorization (NMAF), and/or other techniques.

In one example, at least one label generated in step 212 may indicate more than one root cause. For instance, the processing system may generate a first label that indicates a root cause of “pair issue,” a second label that indicates a root cause of “registration issue,” and a third label that indicates a root cause of “pair issue and registration issue.” This reflects the fact that, in reality, more than one cause may contribute to the occurrence of a condition. Moreover, in some cases, certain combinations of causes may occur together more frequently.

In optional step 214 (illustrated in phantom), the processing system may present the labels generated in step 212 for review by a human subject matter expert. The human subject matter expert may either confirm the assigned root cause labels or may, for one or more of the root cause labels, suggest an alternative root cause label that the human subject matter expert believes to be more accurate. Thus, review of the labels by the human subject matter expert may result in the processing system modifying at least one label.

The method 200 may end in step 216.

Thus, the root cause label assigned to a given set of troubleshooting notes may indicate what is believed to be the root cause of the condition that is associated with the given set of troubleshooting notes. For instance, the condition associated with the given set of troubleshooting notes may be that the display of the customer's laptop computer is blank. In this case, the root cause label may indicate that a faulty RAM is likely to be the reason for the blank display.

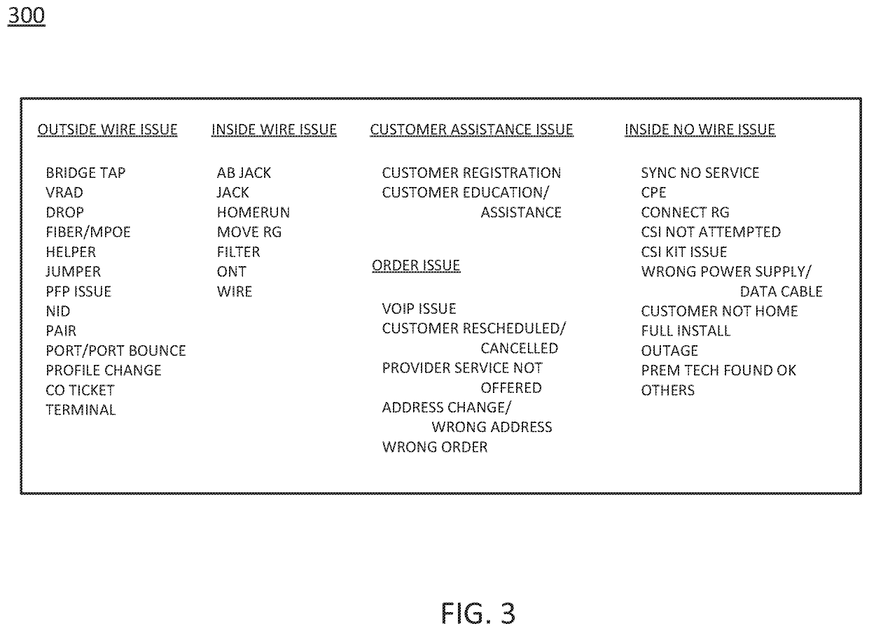

FIG. 3, for instance, illustrates an example set 300 of consolidated root cause labels for an example telecommunications service provider. The root cause labels may be grouped into categories, such as “outside wire issues,” “inside wire issues,” “customer assistance issues,” “order issues,” and “inside no wire issues.” Within each of these categories, there may exist a plurality of more specific root causes. For instance, “outside wire issues” may include conditions for which the root cause is an issue with a bridge tap, and issue with a video ready access device (VRAD), an issue with a drop, an issue with a fiber or a minimum point of entry (MPOE), an issue with a helper, an issue with a jumper, an issue with a preemptive fixed priority (PFP), an issue with a network interface device (NID), an issue with a pair, an issue with a port or port bounce, an issue with a profile change, an issue with a ticket, and/or an issue with a terminal.

“Inside wire issues” may include conditions for which the root cause is an issue with an AB jack, an issue with a jack, an issue with a homerun, an issue with moving a residential gateway (RG), an issue with a filter, an issue with an optical network terminal (ONT), and/or an issue with a wire.

“Customer assistance issues” may include conditions for which the root cause is an issue with customer registration, customer education/assistance, and/or other issues.

“Order issues” may include conditions for which the root cause is an issue with Voice over Internet Protocol (VoIP), an issue with a customer cancelling or rescheduling service, an issue with a provider service not being offered, an issue with a customer address change or a wrong address, and/or an issue with a wrong order.

“Inside no wire issues” may include conditions for which the root cause is an issue with a synchronization of a service or no service, an issue with customer premises equipment (CLE), an issue with connecting an RG, an issue with a called subscriber identification (CSI) being attempted (or not attempted), an issue with a wrong CSI kit, an issue with a wrong power supply or data cable, an issue with a customer not being home, an issue with a full install, an issue with a service outage, an issue with a premises technology being found (or not found), and/or other issues.

As discussed above, the root cause labels generated according to the method 200 may be used to train a classifier to classify sets of unlabeled sets troubleshooting notes according to the root causes of the conditions that the sets of troubleshooting notes are associated with. FIG. 4, for instance, illustrates a flowchart of an example method 400 for classifying the root cause of a reported condition, in accordance with the present disclosure. In one example, steps, functions, and/or operations of the method 400 may be performed by a device as illustrated in FIG. 1, e.g., the application server 106 or any one or more components thereof (e.g., the root cause classifier 116), where the device has been trained using labeled training data (e.g., sets of troubleshooting notes that are labeled with associated root causes). In one example, the steps, functions, or operations of method 400 may be performed by a computing device or system 600, and/or a processing system 602 as described in connection with FIG. 6 below. For instance, the computing device 600 may represent at least a portion of the application server 106 in accordance with the present disclosure. For illustrative purposes, the method 400 is described in greater detail below in connection with an example performed by a processing system, such as processing system 602.

The method 400 begins in step 402. In optional step 404 (illustrated in phantom), the processing system may perform at least one natural language processing-based pre-processing technique on a set of troubleshooting notes that is associated with a customer call, where the customer call reports a condition with a technology service or product. As discussed above, the customer call may comprise a voice call, a text messaging exchange, a Web chat interaction, or any other form of interaction in which a customer may communicate with a technical support representative in order to report and attempt to resolve a condition with a technology service or product.

The set of troubleshooting notes may include information noted by the technical support representative as the technical support representative attempted to resolve the reported condition, as opposed to any statements that may have been verbalized during the interaction with the customer. For instance, the troubleshooting notes may be meant to help other technical support representatives who may attempt to resolve similar conditions in the future. The troubleshooting notes might include, for example, actions that were taken in an attempt to resolve the condition that failed, actions that were taken in an attempt to resolve the condition that succeeded or partially succeeded, identities of other individuals or experts who may have been consulted by the technical support representative, and/or other information. As an example, the set of troubleshooting notes may read, “Jumper disconnected at cross box replaced rg no getting service smart chatted to get rg in service left sp” or “Repair rg going in and out, swapped rg, relocated rg to living room. New ab jack rg up lsbbt gtg, cx ed all services verified.”

The pre-processing operations of step 404 may help to convert the set of troubleshooting notes into a simpler form that is easier to classify. In one example, the at least one natural language processing-based pre-processing technique may be at least one of the following: misspelling correction (e.g., correcting the spelling of misspelled words in a set of troubleshooting notes), stop word removal (e.g., removing stop words—such as “a,” “an,” “the,” “and,” and the like—from a set of troubleshooting notes), identification of domain- or service provider-specific terminology (e.g., the abbreviation “RG” in a set of troubleshooting notes may be short for “residential gateway” if the set of troubleshooting notes comes from a telecommunications service provider, or the abbreviation “CX” may be short for “customer experience”), normalization of numbers and combinations of letters and numbers (e.g., spelling out numbers that have been indicated in numeric form), and lemmatization of inflected forms of words (e.g., converting the modified form of a word—which may be used to express a particular tense, case, voice, number, or the like—into the word's base form).

In optional step 406 (illustrated in phantom), the processing system may perform word representation processing on the set of troubleshooting notes. The word representation processing may further simplify the set of troubleshooting notes for classification. In one example, a bag of words model may be used to simplify the set of troubleshooting notes by representing the text of the set of troubleshooting notes as a multiset of words (disregarding grammar and word order). For instance, the bag of words model may indicate how many times each word of a plurality of words appears in the set of troubleshooting notes. In further examples, the bag of words model may indicate a term frequency-inverse document frequency (TF-IDF) statistic for the set of troubleshooting notes. The TF-IDF may reflect, for instance, how important particular words are to the set of troubleshooting notes.

In another example, a word embedding model may be used to simplify the set of troubleshooting notes by mapping words or phrases appearing in the set of troubleshooting notes to a vector of real numbers. In one example, the word embedding model may comprise a word2vec model, a fastText model, a GloVe model, or a bidirectional encoder representations from transformers (BERT) model.

In step 408, the processing system may generate a plurality of predictions for the set of troubleshooting notes, where each prediction of the plurality of predictions indicates a likelihood that a root cause of the condition associated with the troubleshooting notes is one of a plurality of predefined root causes. For instance, the plurality of predefined root causes may include at least some of the root causes shown in FIG. 3. In one example, the plurality of predefined root causes includes at least one predefined root cause that is a combination of at least two root causes, as described in connection with FIG. 2. The processing system may determine, for each root cause of the plurality of root causes, the likelihood that the root cause is a root cause of the condition associated with the troubleshooting notes.

In one example, the processing system may include a plurality of binary classifiers, where each binary classifier of the plurality of binary classifiers corresponds to one root cause of the plurality of root causes (or to one combination of at least two root causes). Each binary classifier may take as input the set of troubleshooting notes (which may have been preprocessed and simplified as described above) and may output a corresponding binary indicator that indicates whether the associated root cause is likely or unlikely to be a root cause of the condition associated with the troubleshooting notes. In one example, each binary classifier of the plurality of binary classifiers comprises a supervised deep learning model, such as a recurrent neural network (RNN) or a bidirectional long short-term memory (LSTM) model. In one example, each binary classifier of the plurality of binary classifiers may comprise the same type of binary classifier (e.g., all RNNs). However, in another example, at least two binary classifiers of the plurality of binary classifiers may comprise different types of binary classifiers.

In one example, each binary classifier of the plurality of binary classifiers may output a zero when the associated root cause is unlikely to be a root cause of the condition and may output a one when the associated root cause is likely to be a root cause of the condition. In one example, a condition may have more than one root cause; thus, the plurality of predictions may include more than one prediction for which the output of the binary classifier is positive (e.g., likely, or one).

In step 410, the processing system may encode at least two of the plurality of predictions generated in step 408 into a single vector which concatenates a plurality of bits, where each bit of the plurality of bits represents one prediction of the at least two of the plurality of predictions. In one example, each bit of the plurality of bits may represent the output of one of the binary classifiers. For instance, each binary classifier may output a zero when the root cause that the binary classifier is trained to identify is unlikely to be a root cause of the condition. Similarly, each binary classifier may output a one when the root cause that the binary classifier is trained to identify is likely to be a root cause of the condition.

In this case, the plurality of predefined root causes may include “outside issue,” “inside issue,” “inside no wire issue,” “order issue,” and “customer assistance issue.” The binary classifier for “outside issue” may output a one (likely); the binary classifier for “inside issue” may output a zero (unlikely); the binary classifier for “inside no wire issue” may output a zero (unlikely); the binary classifier for “order issue” may output a zero (unlikely); and the binary classifier for “customer assistance issue” may output a one (likely). The resultant vector encoding the plurality of predictions may therefore be the five-bit vector [1, 0, 0, 0, 1], where each bit of the vector corresponds to one of the binary classifiers, and the value of each bit represents the output of the corresponding binary classifier. As can be seen from this example, the single vector may indicate that at least two root causes of the plurality of predefined root causes are likely to have contributed to the occurrence of the reported condition. However, in other examples, the single vector may indicate a single root cause, or may indicate that more than two root causes contributed to the occurrence of the reported condition.

Thus, as described above, the vector that is output in step 410 may indicate that more than one root cause is likely for a given condition associated with a set of troubleshooting notes. This stands in contrast to conventional root cause analysis techniques, in which potential root causes tend to have mutually exclusive relationships. That is, conventional techniques tend to identify a single root cause as the reason for condition, even though, in reality, multiple causes may contribute (in equal or unequal measures) to a reported condition. For instance, installation of hardware by a customer may fail due to both an outside issue (e.g., a pair issue) and due to a customer assistance issue (e.g., a registration issue).

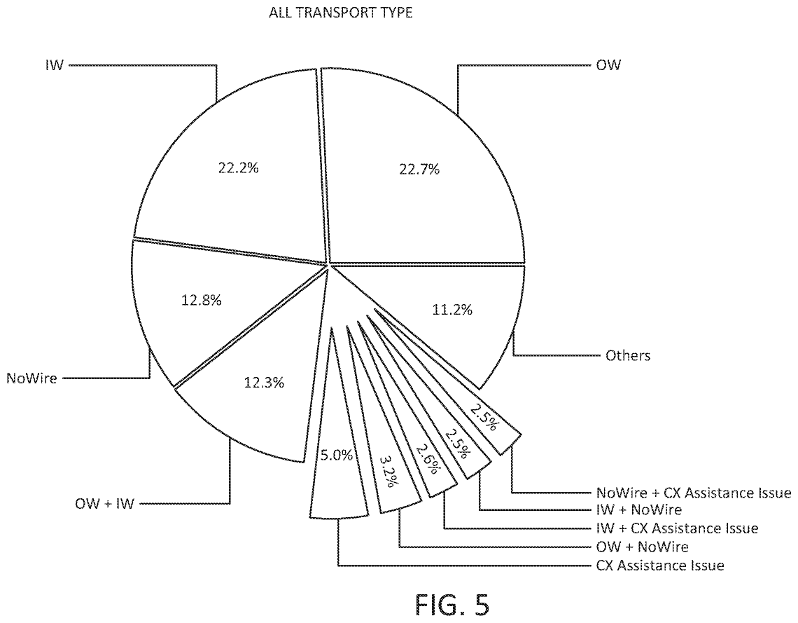

In optional step 412 (illustrated in phantom), the processing system may generate a report, by aggregating the vector with a plurality of additional vectors that have been similarly generated for a plurality of additional sets of troubleshooting notes. The report may help technical support representatives to identify the most common root causes of customer-reported conditions over time. FIG. 5, for instance, illustrates an example report that may be generated from a plurality of vectors that are generated in accordance with steps 404-410 of the method 400 of FIG. 4. In the example of FIG. 5, the report is in the form of a pie chart, where each individual “slice” of the pie chart is associated with a different root cause of a plurality of possible root causes. In other examples, however, the report may take other forms (e.g., bar graphs, frequency distributions, scatter graphs, etc.). In one example, the report may be periodically recalculated (e.g., every x hours, every x days, after every x customer calls, etc.) in order to help identify changing trends. For instance, if a particular root cause that consistently accounts for approximately five percent of all customer-reported conditions suddenly accounts for twenty percent of all customer-reported conditions, this may indicate the occurrence of a larger failure with the potential to affect an even greater number of customers. Being able to identify changes of these types at an early stage may help the providers of products and services to make repairs sooner and thereby limit the extent of the damage caused.

The method 400 may end in step 414.

Although not specifically specified, one or more steps, functions or operations of method 200 or method 400 may include a storing, displaying, and/or outputting step as required for a particular application. In other words, any data, records, fields, and/or intermediate results discussed in the methods can be stored, displayed, and/or outputted either on the devices executing the methods or to other devices, as required for a particular application. Furthermore, steps, blocks, functions or operations in FIG. 2 or FIG. 4 that recite a determining operation or involve a decision do not necessarily require that both branches of the determining operation be practiced. In other words, one of the branches of the determining operation can be deemed as an optional step. Moreover, steps, blocks, functions or operations of the above described method 200 or method 400 can be combined, separated, and/or performed in a different order from that described above, without departing from the example examples of the present disclosure.

As such, the present disclosure provides at least one advancement in the technical field of root cause analysis. For instance, in one example, the present disclosure provides a machine learning model that may identify at least two root causes of a condition that is associated with an unlabeled set of troubleshooting notes. The at least two root causes may be encoded in a single vector that identifies the respective likelihoods of a plurality of predefined root causes (including the at least two root causes) contributing to the occurrence of the condition.

Further examples of the present disclosure perform use automatic, natural language processing techniques to generate training data for training the machine learning model. In particular, the natural language processing techniques may be used to assign labels to conditions based on sets of troubleshooting notes associated with the conditions, where the labels identify likely root causes of the conditions. This process may also help to define the plurality of predefined root causes, e.g., by identifying the most frequently occurring root causes. The natural language processing techniques may be faster and less prone to reading biases than human subject matter experts, which may improve the accuracy of the assigned labels.

FIG. 6 depicts a high-level block diagram of a computer suitable for use in performing the functions described herein. As depicted in FIG. 6, the system 600 comprises one or more hardware processor elements 602 (e.g., a central processing unit (CPU), a microprocessor, or a multi-core processor), a memory 604, e.g., random access memory (RAM) and/or read only memory (ROM), a module 605 for performing root cause analysis, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method 200 or method 400 as discussed above is implemented in a distributed or parallel manner for a particular illustrative example, i.e., the steps of the above method 200 or method 400, or each of the entire method 200 or method 400 is implemented across multiple or parallel computers, then the computer of FIG. 6 is intended to represent each of those multiple computers.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computer or any other hardware equivalents, e.g., computer readable instructions pertaining to the method(s) discussed above can be used to configure a hardware processor to perform the steps, functions and/or operations of the above disclosed method.

In one example, instructions and data for the present module or process 605 for performing root cause analysis (e.g., a software program comprising computer-executable instructions) can be loaded into memory 604 and executed by hardware processor element 602 to implement the steps, functions or operations as discussed above in connection with the illustrative method 200 or 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for performing root cause analysis (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not a limitation. Thus, the breadth and scope of the present disclosure should not be limited by any of the above-described examples, but only in accordance with the following claims and their equivalents.

What is claimed is:

1. A method comprising:
acquiring, by a processing system of a customer support system, a set of troubleshooting notes, wherein the set of troubleshooting notes is generated by a human customer support representative in response to a condition that is reported by a customer, and wherein the troubleshooting notes are written in natural language;
generating, by the processing system, a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers; and
encoding, by the processing system, at least two of the plurality of predictions into a single vector which concatenates a plurality of bits, wherein each bit of the plurality of bits represents one prediction of the at least two of the plurality of predictions.

2. The method of claim 1, wherein the plurality of predefined root causes includes at least one predefined root cause that is a combination of at least two root causes.

3. The method of claim 1, wherein each binary classifier of the plurality of binary classifiers comprises a supervised machine learning model that is trained to identify a respective one root cause of the plurality of predefined root causes.

4. The method of claim 3, wherein at least one binary classifier of the plurality of binary classifiers comprises a recurrent neural network.

5. The method of claim 3, wherein at least one binary classifier of the plurality of binary classifiers comprises a bidirectional long short-term memory model.

6. The method of claim 3, wherein each binary classifier of the plurality of binary classifiers outputs a zero when the root cause is unlikely to be the respective one of the plurality of predefined root causes, and wherein the binary classifier outputs a one when the root cause is likely to be the respective one of the plurality of predefined root causes.

7. The method of claim 1, wherein the single vector concatenates a plurality of outputs, and wherein each output of the plurality of outputs is generated by a respective one binary classifier of the plurality of binary classifiers.

8. The method of claim 1, further comprising:
prior to the generating, pre-processing, by the processing system, the set of troubleshooting notes using a natural language processing technique.

9. The method of claim 8, wherein the pre-processing comprises correcting a misspelling in the set of troubleshooting notes.

10. The method of claim 8, wherein the pre-processing comprises removing a stop word from the set of troubleshooting notes.

11. The method of claim 8, wherein the pre-processing comprises identifying domain-specific terminology in the set of troubleshooting notes.

12. The method of claim 8, wherein the pre-processing comprises spelling out a number that is indicated in numeric form in the set of troubleshooting notes.

13. The method of claim 8, wherein the pre-processing comprises lemmatizing an inflected form of a word appearing in the set of troubleshooting notes.

14. The method of claim 1, further comprising:
prior to the generating, converting, by the processing system, the set of troubleshooting notes into a multiset of words.

15. The method of claim 1, further comprising:
prior to the generating, computing, by the processing system, a term frequency-inverse document frequency statistic for the set of troubleshooting notes.

16. The method of claim 1, further comprising:
prior to the generating, mapping, by the processing system, a plurality of words appearing in the set of troubleshooting notes to a vector of real numbers.

17. The method of claim 1, wherein the single vector indicates that at least two root causes of the plurality of predefined root causes are likely to have contributed to an occurrence of the condition.

18. The method of claim 1, further comprising:
aggregating, by the processing system, the single vector with a plurality of additional vectors, wherein each vector of the plurality of additional vectors has been generated in a manner similar to the single vector for one additional set of troubleshooting notes of a plurality of additional troubleshooting notes; and
identifying, by the processing system, a plurality of most common root causes associated with conditions reported by customers over time.

19. A non-transitory computer-readable storage device storing a plurality of instructions which, when executed by a processing system of a customer support system, cause the processing system to perform operations, the operations comprising:
acquiring a set of troubleshooting notes, wherein the set of troubleshooting notes is generated by a human customer support representative in response to a condition that is reported by a customer, and wherein the troubleshooting notes are written in natural language;
generating a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers; and
encoding at least two of the plurality of predictions into a single vector which concatenates a plurality of bits, wherein each bit of the plurality of bits represents one prediction of the at least two of the plurality of predictions.

20. An apparatus comprising:
a processing system of a customer support system; and
a non-transitory computer-readable storage device storing a plurality of instructions which, when executed by a processing system of a customer support system, cause the processing system to perform operations, the operations comprising:
acquiring a set of troubleshooting notes, wherein the set of troubleshooting notes is generated by a human customer support representative in response to a condition that is reported by a customer, and wherein the troubleshooting notes are written in natural language;
generating a plurality of predictions for the set of troubleshooting notes, wherein each prediction of the plurality of predictions indicates a likelihood that a root cause of the condition is a different one of a plurality of predefined root causes, and wherein each prediction of the plurality of predictions is generated using a different binary classifier of a plurality of binary classifiers; and
encoding at least two of the plurality of predictions into a single vector which concatenates a plurality of bits, wherein each bit of the plurality of bits represents one prediction of the at least two of the plurality of predictions.
